(19) United States
(12) Patent Application Publication
(10) Pub. No.: US 2010/0239324 A1
(43) Pub. Date: Sep. 23, 2010

(54) SYSTEM AND METHOD FOR PRODUCING A DRY TONER ASSOCIATED WITH A SELECTED GLOSS LEVEL

(75) Inventors: James A. Winters, Alfred Station, NY (US); Kip L. Jugle, Bloomfield, NY (US)

Correspondence Address: Xerox Corporation (CDFS), 445 Broad Hollow Rd.-Suite 420, Melville, NY, 11747, US

(73) Assignee: Xerox Corporation, Norwalk, CT (US)

(21) Appl. No.: 12/407,862

(22) Filed: Mar. 20, 2009

(51) Int. Cl. G03G 15/08; G03G 5/00; G03G 9/00; G03G 9/08

(52) U.S. Cl. 399/259; 430/137.21; 430/111.4; 430/111.41

(57) ABSTRACT

A system and method for producing toner associated with a selectable gloss level is provided. The method includes holding a first toner formed of particles, associated with a relatively low gloss level, and having two particle properties, each having a first and second characteristic, respectively, and holding a second toner formed of particles, associated with a relatively high gloss level, and having the two particle properties, each having a third and fourth characteristic, respectively. The first and third and the second and fourth characteristics are substantially the same. The first and second toners are transported and a ratio of their respective volumes is determined so that when blended a third toner is produced which is associated with a selected gloss level that is in-between the low and high gloss levels. The transporting is controlled in accordance with the determined ratio.

### BACKGROUND

The present disclosure relates generally to producing toner associated with a selected gloss level. In particular, the present disclosure relates to combining a first and second dry toner, each associated with a known gloss level which is different than the other's, to produce a third toner associated with the selected gloss level.

With the advent of digital printing, it is common for users to be provided with the ability to adjust many aspects of the printing for obtaining a desired output. Output gloss level can be controlled by using a toner associated with a desired gloss level, however the gloss level associated with the toner can only be altered in the polymer selection of the inks at the beginning of an ink design, which does not afford a user with the ability to tune the associated gloss level from job to job. Another way to adjust the associated gloss level is to use a coating which is deposited over printed output for increasing or decreasing the gloss. Applying the coating requires applying an additional layer over the ink, adding costs and constraints.

### SUMMARY

The present disclosure is directed to a method for method for producing toner having a selectable gloss level. The method includes holding a first toner and holding a second toner. The first toner is formed of particles, is associated with a relatively low gloss level and has at least two particle properties, each of the at least two particle properties having a first and second characteristic, respectively. The second toner is formed of particles, is associated with a relatively high gloss level and has the at least two particle properties, each of the at least two particle properties having a third and fourth characteristic, respectively. The first and third and the second and fourth characteristics are substantially the same, which enables the first and second toners to blended into a third toner for forming a substantially homogeneous mixture. The method further includes transporting the first and second toners, and determining a ratio of volume of the first and second toners that when blended produces the third toner to be associated with a selected gloss level that is in between the low gloss level and the high gloss level. Finally, the method includes controlling the transporting of the first and second toners so that a ratio of a volume of the transported first and second toner is in accordance with the determined ratio, and blending the transported first and second toners to produce the third toner.

The present disclosure is also directed to a developer unit of a printer device. The developer unit includes a first receptacle for holding a first toner formed of particles, associated with a relatively low gloss level, and having at least two particle properties, each of the at least two particle properties having a first and second characteristic, respectively,. The developer unit further includes a second receptacle holding a second toner formed of particles, associated with a relatively high gloss level, and having the at least two particle properties, each of the at least two particle properties having a third and fourth characteristic, respectively. The first and third and the second and fourth characteristics are substantially the same, which enables the first and second toner to be blended to form a third toner which is a substantially homogeneous mixture. The developer unit further includes a transport system for transporting the first and second toners, at least one blending device for blending the transported first and second toners to produce the third toner, and a controller for controlling the transporting so that the ratio of the volume of the transported first toner to the volume of the transported second toner is selected for the third toner to be associated with a selected gloss level in between the low gloss level and the high gloss level.

The present disclosure is also directed to a toner having tunable gloss. The toner having tunable gloss includes a homogeneous mixture of a first toner formed of particles, associated with a relatively low gloss level, and having at least two particle properties, each of the at least two particle properties having a first and second characteristic, respectively. The S homogeneous mixture further includes a second toner formed of particles, associated with a relatively high gloss level, and having the at least two particle properties, each of the at least two particle properties having a third and fourth characteristic, respectively. The first and third and the second and fourth characteristics are substantially the same, which enables the toner having the tunable gloss to be blended into a substantially homogeneous mixture. A proportion of the first and second toners is selected for the toner having tunable gloss to be associated with a selected gloss level.

Other features of the presently disclosed system and method for producing toner with a selected gloss level will become apparent from the following detailed description, taken in conjunction with the accompanying drawings, which illustrate, by way of example, the presently disclosed system and method for producing toner.

### BRIEF DESCRIPTION OF THE DRAWINGS

Various embodiments of the present disclosure will be described below with reference to the figures, wherein:

FIG. 1 is a toner producing system for producing toner associated with a selectable gloss level in accordance with the present disclosure;

FIG. 2 is a flowchart of steps performed by a controller of the toner producer system shown in FIG. 1;

FIG. 3 is a block diagram of an exemplary printing device producing toner associated with a selectable gloss level in accordance with the present disclosure;

FIG. 4 is a perspective view of a developer unit of the printing device shown in FIG. 3 with a housing of the developer unit cut away;

FIG. 5 is an end view of a blend and charge device and a particle transfer device of the developer unit shown in FIG. 4;

FIG. 6 is a block diagram of a transport system of the developer unit shown in FIGS. 4 and 5;

FIG. 7 is a block diagram of another embodiment of a printing device producing toner associated with a selectable gloss level in accordance with the present disclosure; and

FIG. 8 is a flow diagram showing steps performed by a printing device using toner associated with a selectable gloss level for a printing job.

### DETAILED DESCRIPTION

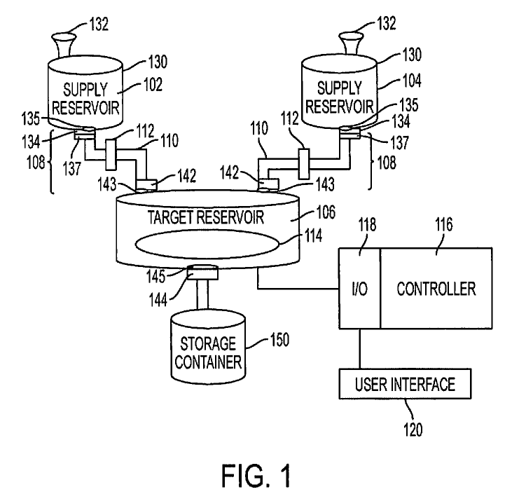

Referring now to the drawing figures, in which like references numerals identify identical or corresponding elements, the system and method for producing dry toner with a selected gloss level in accordance with the present disclosure will now be described in detail. With initial reference to FIG. 1, an exemplary system for producing toner associated with a selectable gloss level in accordance with the present disclosure is illustrated and is designated generally as toner producing system 100. Toner producing system 100 includes a first supply reservoir 102 for holding a supply of a first toner associated with a first gloss level, a second supply reservoir 104 for holding a supply of a second toner associated with a second glass level that is different than the first gloss level and a target reservoir 106 for holding a mixture of the first and second toners. A transport system 108 is provided for transporting the first and second toner from the first and second supply reservoirs, respectively, to the target reservoir 106. Each transport system 108 is provided with a passageway 110 and at least one transport control device 112 that controls the quantity or toner that is transported from the associated supply reservoir 102 or 104 to the target reservoir 106. The target reservoir 106 is provided with a blending device 114 that dry blends the first and second toners delivered to the target reservoir 106 for transforming the first and second toners into a homogeneous mixture.

The toner producing system 100 is further provided with a controller 116 having at least one input/output (I/O) interface 118 for receiving data input including a target gloss level and outputting control signals to the at least one transport control devices 112 for controlling the amount of and relative proportions of the first and second toners transported from each of the first and second storage reservoirs 102 and 104 to the target reservoir 106. Furthermore, the controller 116 may control the blending device 114 for dry blending the material in the target reservoir 106 when needed and to the degree needed.

In the present example, the first and second toners are both made of dry particles, and their particles must be substantially identical with respect to certain properties in order that when dry blended together the blended mixture will be homogenous, including that the particles will not separate from one another in the blended mixture either immediately or over time. In particular, several dry particle property criteria for homogeneous blending must be met. First, the particle size distribution for the first and second toners must be substantially equal. This may be achieved during production of the first and second toner, such as at a toner producing plant, production is controlled for producing the first and second toner with a selected particle size and distribution, where each of the particle size and the particle distribution is selected to be substantially the same for the first and second toners. This may be done, for example by using conventional and/or chemical methods for producing the first and second toners and by controlling processing equipment and properties, such as grinders, classifiers, chemical reactors, and process set-points.

Second, the potential triboelectric distribution of the first and second toners must be substantially equal. This is achieved by selecting toner recipe and process set-points at the processing stage, e.g., selecting resin types, pigment types, external additive types and amounts, internal additives and amounts, etc. Third, the types and levels of all external additives must be substantially equal. External additives refers to additives which are mechanically attached to the toner particles, as opposed to internal additives which are integrated into the particle. External additives are susceptible to be removal and reattachment, which can cause interactions with the toner particles in contact. The requirement for substantially equal types and levels of all external additives minimizes these interactions. Finally, any triboelectric charging that occurs during any processing of the first and second toners in which the first and second toners are charged at the dry blending stage must occur at substantially the same rate for the first and second toners, and accordingly, the first and second toners must have substantially the same triboelectric charge at any stage of the dry blending stage.

The first and second supply reservoirs 102 and 104 are configured for holding toner made of dry particles. The first and second supply reservoirs 102 and 104 each include a housing 130 forming an open or closed container configured for holding the dry particles. When the housing 130 forms a closed container, as shown in FIG. 1, it is provided with a mouth 132 through which the respective supply reservoirs 102 and 104 receive toner from an external source before and/or during a blending operation. The mouth 132 may be provided with a valve or cover 133 or the equivalent for closing the mouth 132 or controllably allowing toner to flow into the supply reservoir 102 or 104.

Each housing 130 is further provided with a discharge port 134 for discharging toner held in the associated supply reservoir 102 and 104 to the transport system 108. The discharge port 134 may be provided with a valve 135, or the equivalent, for opening or closing the discharge port 134, such as a cover or a valve, in order to controllably allow toner to be discharged from the associated supply reservoir 102 or 104 to the transport system 108. The discharge port 134 further may be provided with a dry powder pump 137 or the equivalent for assisting in discharging the toner into the transport system 108 and controlling the rate of discharge. The valve 135 and the pump 137 are considered as part of the at least one transport control device 112 which is controlled by the controller 116 and is described further below. The first and second reservoirs 102 and 104 may be positioned above the target reservoir 106 such that gravity assists in the discharge of the first and second toner into the transport system 108. In this case, the pump 137 may not be needed.

The first and second supply reservoirs 102 and 104 may further include means for mixing (not shown) the supply toner stored within for preventing the particles from settling and becoming compacted, and to keep the toner fluffy in order that the toner flows well during transport. Such means for mixing are well known in the art, and may include a means for rotating the supply reservoirs 102 and 104, an auger, a blender, providing the inner walls with fluting and/or providing an air stream directed at the toner.

The transport system 108 is a controlled dry particle transport system, such as a transport system that is well known to a person having ordinary skill in the art. The transport system's passageway 110 may be a conduit such as a closed pipe, plastic tubing or an open trough or chute with adequate dust collection. The toner discharged from the first or second supply reservoirs 102 and 104 is discharged into the passageway 110.

Each transport control device 112 is associated with one of the first and second supply reservoirs 102 and 104 and controls the rate of flow of the toner from the discharge port 134 of the associated supply reservoir 102 or 104 along the passageway 110 and into the target reservoir 106. A variety of transport control devices 112 are known to those having ordinary skill in the art and are within the scope of the present disclosure. Examples of transport control devices 112 that may be used are dry powder pumps or valves (e.g., butterfly valves) positioned along the passage way or at the discharge ports 134 of the first or second reservoir tanks 102 or at an intake port of the target reservoir 106 (described in further detail below); a device for creating an air stream, such as by blowing air or gas (e.g., via a fan or from a pressurized gas source) or by sucking air (e.g., via a fan, suction device and/or a change in air pressure); a device for recovering powder from an air stream, and/or an auger). The at least one transport control device 112 may be actuated by a device, such as a motor (not shown), which is controlled by the controller 116 for controlling the rate of transport and the volume of material that is transported by the transport system 108.

The target reservoir 106 is configured for holding toner made of dry particles. The target reservoir 106 includes a housing 140 forming an open or closed container configured for holding the dry particles. When the housing 140 forms a closed container, as shown in FIG. 1, it is provided with at least one mouth 142 through which the target reservoir 106 receives toner from the transport system during a blending operation using blending device 114. The mouth 142 may be provided with an intake device 143, such as a valve or cover for controlling flow of toner into the target reservoir 106 or a device for drawing toner into the target reservoir 106, such as a fan, auger, pump, and/or device for creating negative air pressure. The intake device 143 is considered as part of the at least one transport control device 112 which is controlled by the controller 116 which is described further below.

The target reservoir 106 may also be provided with a discharge port 144 in fluid communication with a storage container 150 via a conduit 152. The discharge port 144 may be provided with a flow control means 145, such as valve, cover, pump and/or the equivalent, for controlling the discharge of the toner mixture from the target reservoir 106 to the storage container 150. The flow control means 145 is controlled by the controller 116 for allowing the homogeneous mixture of toner that is blended in the target reservoir 106 to flow from the target reservoir 106 into the storage container 150. The storage container may be physically positioned below the target reservoir 106 so that the flow of the homogeneous toner mixture into the container is at least partially facilitated by gravity. The flow of the homogeneous toner mixture into the container 150 may be continuous or in batches.

The target reservoir 106 is provided with at least one dry particle blending device 114 for blending the particles of the first and second toners within the target reservoir 106 for producing a homogeneous toner mixture formed from the first and second toners. Dry particle blending devices 114 are well known in the art, and may include, for example, a means for rotating the target reservoir 106, one or more augers, one or more blenders, providing the inner walls of the housing 140 with fluting and/or providing an air stream within the target reservoir 106 which may be directed at the toner. The blending is performed at a low intensity sufficient to blend the particles but not aggressive enough to change the particles themselves.

The controller 116 is a computing device having a processor, data communication capabilities and access to data storage. The controller 116 may be, for example, a Microcontroller, a microprocessor, a personal computer, a mobile device (e.g., a PDA, cellular phone), a laptop, a server, etc. The controller 108 further includes the I/O interface 118 for interfacing with devices that the controller controls and for receiving input, such as from a user or another processor. A user interface (UI) 120 may be provided which is in data communication with the I/O interface 118. The UI 120 may be integrated with the controller 116 or be external to and in data communication with the controller 116. The UI 120 may include, for example, a data input device (not shown), such as a keypad, dials or levers, a graphical user interface (GUI) (not shown) and/or a display device (not shown), such as an LED screen or a computer monitor.

While FIG. 1 and the related description above show and describe a system which includes automated transport, the transport of the first and second toners may be performed partially or entirely manually. For example, the first and second toner may be measured, e.g., by measuring weight or volume, manually in the corrected proportions, where the proportion is determined in accordance with a function or equation which may be determined previously for achieving the desired result. The measured first and second toners may be manually placed in target reservoir 106 where the first and second toners held within are blended by blending device 114. Such manual placement may be performed, for example, using a vessel, such as a bucket, configured for carrying powders or liquids.

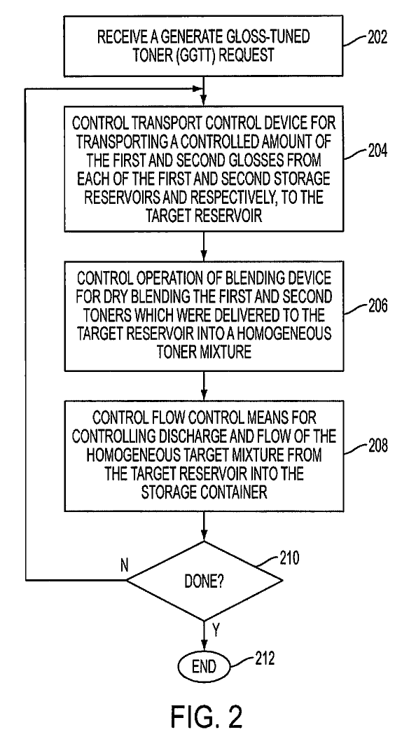

With reference to FIG. 2, operation of the controller 116 and toner producing system is now described. The processor of the controller 116 executes a software module for performing the steps shown in FIG. 2. The software module includes a series of programmable instructions capable of being executed by the processor of the controller 116. The series of programmable instructions can be stored on a computer-readable medium, such as RAM, a hard drive, CD, smart card, 3.5″ diskette, etc., or transmitted via propagated signals for being executed by the processor for performing the functions disclosed herein and to achieve a technical effect in accordance with the disclosure. The functions of the software module may be combined into one module or distributed among a different combination of modules.

At step 202, the controller 116 receives a generate gloss-tuned toner (GGTT) request. The GGTT request may have been received from a user, e.g., via the UI 120, or from another processor, e.g., via the I/O interface. The GGTT request includes a target gloss level and a quantity level. If either of the levels are not specified in the GGTT request, default values (e.g., which may be selected by an administrator) are used. The target gloss level indicates the desired gloss level associated with the homogeneous toner mixture which is produced in the target reservoir 106 by combining the first and second toners. The quantity level indicates the amount of homogeneous toner mixture with the associated target gloss level that should be produced.

At step 204 the controller 114 controls the transport control device 112 for transporting a controlled amount of the first and second glosses from each of the first and second storage reservoirs 102 and 104, respectively, to the target reservoir 106. The controlled amounts of each of the first and second glosses are determined so that the total amount of the first and second toners transported will produce the quantity of homogeneous toner mixture specified in the GGTT request, and the proportions of the first and second toners transported will achieve the target gloss level associated with the homogeneous toner mixture. The first and second toners may be transported in a continual fashion or in batches in accordance with the determined proportions until the requested total amount is achieved. If the total amount of homogeneous toner mixture exceeds the capacity of the storage container 150, the filled storage container 150 may be emptied into another container, or removed and replaced with another storage container 150 as many times as necessary until the requested amount of homogeneous toner is produced and stored. When the requested amount of toner is produced, the storage container 150 (or the last storage container 150 of used for producing the batch) may be removed or emptied into another storage container. The toner produced in the batch is associated with the selected gloss level.

In accordance with one business model, customers may order one or more batches of toner associated with a selected gloss level. Thus customers may order customized toner. In accordance with another business model, a manufacturer may use the toner producing system 100 to produce a plurality of batches associated with a variety of gloss levels. A customer may select from the available toners a toner that is associated with a gloss level that suits his needs.

The ratio of the first and second toners is determined in accordance with a predetermined equation or function. The equation or function may be determined empirically by performing experiments and finding an equation or function that achieves the desired results. An example of a function is as follows:

Gloss=(amount of Toner A)*(gloss level associated with Toner A)+(amount of Toner B)*(gloss level associated with Toner B)+constant EQUATION 1

where Toner A is the first toner, Toner B is the second toner, and constant is determined empirically.

Equation 1 is provided for explanatory purposes only and does not correspond to a specific quantitative system.

Accordingly, the first and second toners are transported from the first and second supply reservoirs 102 and 104 via the transport system 108 in a controlled fashion as controlled by controller 116. The controller 116 controls the amounts and rate of discharged toner from the supply reservoirs 102 and 104, the rate of transport along passageway 110, and/or the rate of intake of target reservoir at each of its at least one mouth 142. This may include controlling any combination of the components of transport control device 112, including valve 135, pump 137, and/or intake device 143.

At step 206, the controller 116 controls operation of blending device 114 for dry blending the first and second toners which were delivered to the target reservoir 106 into the homogeneous toner mixture. The controller 116 may control the blending device 114 to continually blend the material held in the target reservoir 106 as it is delivered or to blend the material when a batch of material has been received in the target reservoir 106. Accordingly, the material held in the target reservoir 106 is blended and transformed into the homogeneous toner mixture.

At step 208, the controller 116 controls flow control means 145 for controlling discharge and flow of the homogeneous target mixture from the target reservoir 106 into the storage container 150, which may be either continuous or in batches. Accordingly, the homogeneous toner mixture is stored in storage container 150.

At step 210, a determination is made if the requested quantity of homogeneous toner mixture has been produced. If not, execution returns to step 204 for continuing the process of transporting the first and second toners to the target reservoir 106. If the determination at step 210 is that the requested quantity of homogeneous toner mixture has been produced, execution ends at step 212.

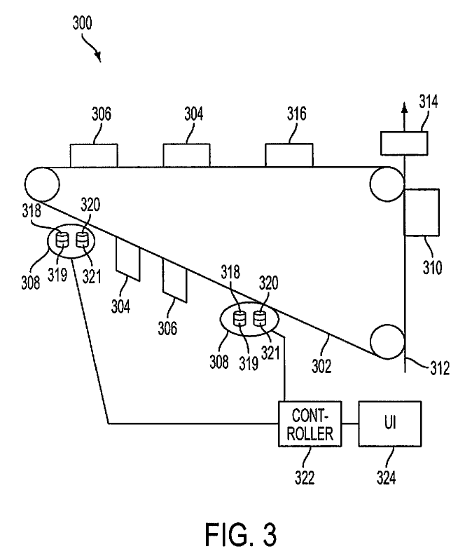

With reference to FIG. 3, a printer device for producing images with an associated tunable gloss level in accordance with the present disclosure is illustrated and is designated generally as printer device 300. The term “printer” as used herein encompasses any apparatus or system, such as a digital copier, xerographic printing system, ink jet printing system, reprographic printing system, bookmaking machine, facsimile machine, multifunction machine, etc., which performs a marking output function for any purpose. The modality for marking may include, for example, applying toner, ink, dye, etc., to the substrate. The substrate may be a material such as paper, cardboard, a transparency, a paper derivative, metal, plastic, glass, wood, cloth, etc.

The printer device 300 may use black toner only for printing a black-and-white printed image and/or may use n non-black color toners for printing a full-colored printed image using any color separation (e.g., cyan, magenta, yellow). The printer device 300 includes a photoreceptor 302, a portion of which is charged to a substantially uniform potential. The photoreceptor 302 is shown here as a belt, but can be provided in a different configuration, such as a drum. The charging is performed by at least one charger device 304, with each charger device 304 corresponding to the process for printing with a respective one of the black and n non-black color toners used by the printer device 300. At least one exposure device 306, including a light source, such as a laser or LED light source, exposes the charged portion of the photoreceptor 302 to a light image of an original document being reproduced or a digital image that is to be printed. This records an electrostatic latent image on the photoreceptor 302 which corresponds to features (such as text or images) contained within the original document or the digital image for which a particular toner (black and/or a non-black color) should be applied to the target substrate for generating an image on the substrate. Each exposure device 306 corresponds to the process for printing with a respective one of the black and/or n non-black color toners used by the printer device 300.

After the electrostatic latent image is formed on the photoreceptor 302, the latent image is developed in at least one developer unit 308 for causing a developer material, such as toner particles adhering triboelectrically to carrier granules, to be attracted to the latent image for forming a powder image on the photoreceptor 302. Each developer unit 308 uses a respective one of the black toner and/or n non-black color toners used by the printer device 300.

The powder image is transferred to a substrate, such as a sheet of paper, at transfer station 310. The substrate path 312 indicates the path followed by the substrate to which the powder image is transferred. After the image transfer, the substrate is heated by fuser 314 to permanently affix the powder image to the substrate. The photoreceptor 302 is cleaned by one or more cleaner devices 316 for removing any charge and/or toner that may be on the photoreceptor 302 in order to be ready for recording a new image on a newly provided substrate or sheet of paper.

The developer unit 308, described in greater detail below, includes a first reservoir 318 holding a first toner 319 associated with a first gloss level and second reservoir 320 holding a second toner 321 associated with a second gloss level different than the first gloss level. The developer unit 308 combines the first and second toners 319 and 321 to form a homogeneous toner mixture associated with a selected gloss level. The first and second toners 319 and 321 satisfy the dry particle property criteria for homogeneous blending described above.

The combining of the first and second toners 319 and 321 for achieving the mixed toner associated with the selected gloss level is controlled by controller 322. The selected gloss level of the combined toner is input to the controller 322, such as via UI 324 or via another processor (not shown).

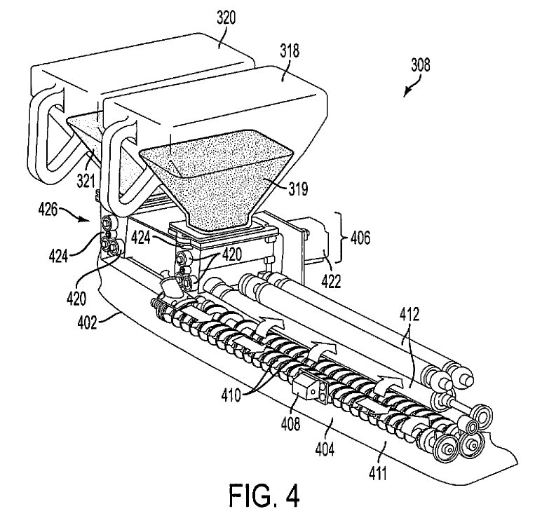

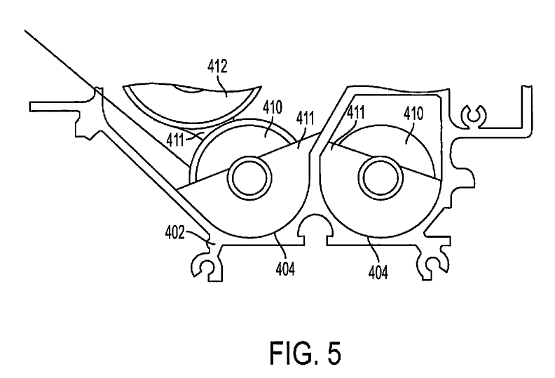

An exemplary developer unit 308 is shown in FIGS. 4 and 5. The developer unit 308 is provided with a housing 402 which forms a sump 404 for receiving toner from reservoirs 318 and 320. Each of the reservoirs 318 and 320 are in fluid communication with a transport system 406. The reservoirs 318 and 320 may be similar to the reservoirs 102 and 104 described above with respect to structure and function. The transport system 402 may be similar to the transport system 108 described above with respect to structure and function.

The transport system 402 is in fluid communication with sump 404 for delivering the first and second toners 319 and 321 from reservoirs 318 and 320, respectively, into the housing 402 where the delivered first and second toners 319 and 321 are received and held by sump 404. The transport system 406 is controlled by controller 322 for delivering the first and second toners 319 and 321 in accordance with a ratio so that the mixed toner is associated with the selected gloss level. At least one dry particle blend and charge device 410 is provided within the sump 404 for blending the particles of the first and second toners 319 and 321 for transforming the first and second toners 319 and 321 into a homogeneous toner mixture 411.

The printer device 300 further determines when additional toner needs to be added to the sump 404, such as via an exemplary sensor 408 that senses the surface level of the toner in the sump 404. The sensor 408 output is provided to a general controller (not shown) of the printer device 300 that controls various components in the printer device 300. When additional toner needs to be added to the sump 404 the controller 322 is notified by the general controller so that the controller 322 may control the ratio of the first and second toners 319 and 321 provided to the sump 404 for achieving the selected gloss level associated with the toner mixture 411 in the sump 404.

In the exemplary embodiment shown in FIGS. 4 and 5, the blend and charge device 410 includes one or more augers. The arrows in FIG. 4 indicate the flow of the toner held in the sump 404, where the flow is caused by the blend and charge device 410 and results in the first and second toners 319 and 321 mixing together to form the homogeneous toner mixture 411. The action of the augers causes the flow indicated by the arrows and thus the mixing of the first and second toners 319 and 321 into the homogeneous toner mixture 411. Additionally, the action of the augers causes the particles of the toner mixture 411 to charge so that particles of the first toner 319 and the particles of the second toner 321 charge uniformly at the same rate. The action of the augers is optimized for mixing the particles of the first and second toners 319 and 321 and charging them uniformly. In FIG. 5 the top surface of the toner mixture 411 is shown lying in a plane which is not horizontal. This indicates that the level of aggression used by the augers in the current example is sufficient to cause the toner mixture to behave in this manner. Yet the level of aggression is further optimized so as not to change the structure of the toner particles being blended, such as to minimize disturb of any additives that are externally attached to the toner particles. If the external additives are disturbed, the external additives of the first and second toners 319 and 321 are disturbed in substantially the same way and degree.

In addition to the first and second toners 319 and 321, carrier granules are introduced into the sump 404. Additionally (or alternatively), the carrier granules may be added to the first and second toner 319 and 321 held in the receptacles 318 and 320. The toner particles in the sump 404 adhere triboelectrically to the carrier granules due at least in part to the charge developed on the toner particles by the blending action of the blender device 410. Since the charging of the particles of the first and second toners 319 and 321 are uniform, the particles of the first toner 319 adhere to the carrier granules in substantially the same way as the particles of the second toner 321, e.g., via the same triboelectric charge and at the same ratios. According to the above, the augers are sufficiently aggressive to cause the triboeletrical charging of the toner particles so that they will adhere to the carrier granules.

The carrier granules, e.g., rounded steel particles which may be provided with a polymer coating to aid in charging of the toner, have magnetic properties. The polymer coating is chosen so that the first and second toners 319 and 321 charge to a selected level at a selected rate. Most of the charging of the toner occurs due to friction between the surface of the toner particles of the first and second toners 319 and 321 and the carrier granules. The homogeneous toner mixture 411 is distributed substantially evenly within the sump 404. Some adhering of the toner mixture 411 to the surface of the augers via the carrier granules may take place, as shown in FIG. 5. From the augers the carrier granules, together with the toner particles that are triboelectrically adhered to them, are transferred to the photoreceptor 302, such as via a particle transfer device 412, which in the example is at least one magnetic roll or magnetic brush as shown in FIGS. 4 and 5. The toner particles of toner mixture 411 are distributed substantially evenly over the portion of the magnetic rolls that communicate with the photoreceptor 302. The carrier granules are attracted to the charged photoreceptor 302 and the toner adhered to the carrier granules forms a powder image on the photoreceptor 302 which is subsequently transferred to a substrate, such as a sheet of paper, at transfer station 310.

The transfer device 412 functions to transport the toner mixture 411 to the photoreceptor 302. In the present example, the magnetic rolls further contribute to assuring that the toner mixture 411 is uniformly charged as well as blended into in a homogeneous mixture.

The blend and charge device 410 is not limited to including one or more augers. For example, the blend and charge device 410 may include mechanisms such as rotating blades (similar to a fan or a blender) or mechanisms for introducing an air flow in the sump 404 (e.g., forced air or a negative air flow) Additionally, the blend and charge device 410 may be provided with one or more corona style charge devices to assist in charging the particles, e.g., in addition to the friction charging methods described above.

The particle transfer device 412 is not limited to including one or more magnetic rolls. For example, the transfer device 412 may employ methods or devices known in the art for transferring the toner mixture 411 to the photoreceptor 302, such as donor rolls, powder cloud, cascade, etc.

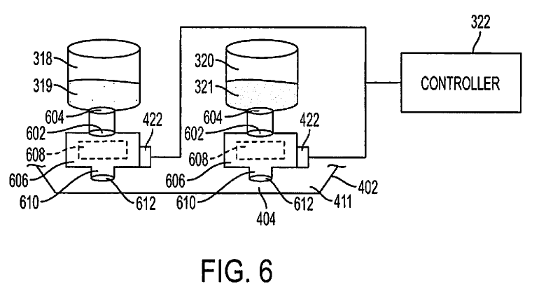

Transport device 406 and control thereof are now discussed in greater detail with respect to FIGS. 4 and 6. Each receptacle 318 and 320 is provided with a first discharge port 602 which may have a first valve or cover 604 that controls the flow of toner particles through the discharge port 602. The discharge port 602 is in fluid communication with a transport passageway 606 which may be provided with a transport mechanism 608 for assisting in transporting toner through the transport passageway 606. Gravity may further assist in transporting the toner. The transport passageway 606 is in fluid communication with sump 404, e.g., via a second discharge port 610 having a second valve or cover 612. Alternatively, the transport passageway 606 may have an open bottom through which the toner particles flow. In FIG. 6 an exemplary view is shown in which valves 604 are in a closed state and the first and second toners 319 and 321 are not presently flowing. Toner mixture 411 which has already been produced from first and second toners 319 and 321 is shown held in sump 404.

In the present example, the transport mechanism 608 is driven by an actuator 614. The transport of the first and second toners 319 and 321 is controlled by the first valve 604, the transport mechanism 608 which is actuated by the actuator 614, and the second valve 612. The controller 322 controls actuation of the first and second valves 604 and 612 and the actuator 614 for controlling transport of each of the first and second toners 319 and 321 so that the ratio of the first and second toners 319 and 321 is such that the toner mixture 411 will be associated with the selected gloss. The ratio of the first and second toners 319 and 321 is determined in accordance with a predetermined equation or function. The equation or function may be determined empirically by performing experiments and finding an equation or function that achieves the desired results. A non-limiting example of an equation that can be used for determining the ratio is Equation (1) above.

In the present example, as shown in FIGS. 4 and 6, the transport mechanism 608 includes at least one auger that assists and controls transportation the toner from the associated receptacle through the associated transport passageway 606 to the sump 404. In. FIG. 4, the augers of the transport mechanism 608 are supported by bearings 420 which are mounted to end walls 424 of a structure 426 that houses the transport passageway 606. In the present example the actuator 614 is a step motor, such that the speed of the step motor controls the volume of toner that flows from the associated receptacle to the sump 404.

The transport mechanism 608 is not limited to including augers, and may include other dry particle transport mechanisms, such as a dry powder pumps; a valve (e.g., butterfly valves) positioned along the transport passageway 606; a device for creating an air stream, such as by blowing air or gas (e.g., via a fan or from a pressurized gas source) or by sucking air (e.g., via a fan, suction device and/or a change in air pressure); and/or a device for recovering powder from an air stream. The actuator 614 may be any device capable of actuating the transport mechanism 608, and may include mechanical and/or electrical components.

The controller 322, similar in function to controller 116 described above, is a computing device having a processor, data communication capabilities and access to data storage. The controller 322 may be, for example, a microcontroller, a microprocessor, a personal computer, a mobile device (e.g., a PDA, cellular phone), a laptop, a server, etc. The controller 322 receives a selected gloss level, such as from another processor or via user interface 324. The controller 322 may be external to the printer device 300 or may be integrated with the printer device 300. The UI 324 may be integrated with the controller 322 or be external to the controller 322 and in data communication with the controller 322. The UI 324 may include, for example, a data input device (not shown), such as a keypad, dials or levers, a graphical user interface (GUI) (not shown) and/or a display device (not shown), such as an LED screen or a computer monitor or use a display device and/or data input device which already exists, e.g., is provided at a console on the printer device 300.

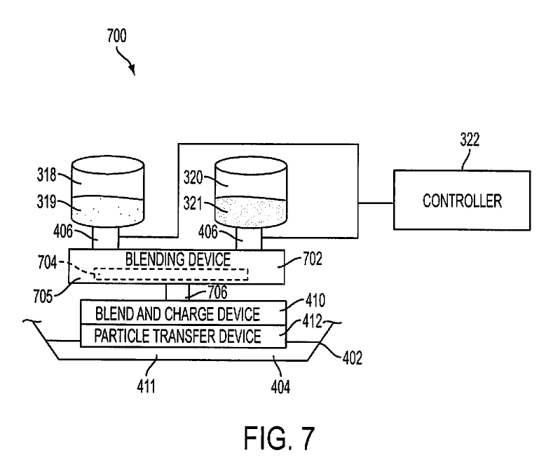

FIG. 7 shows another embodiment of a developer unit 700 in which a blending receptacle 702 is provided which receives the first and second toner 319 and 321 from the receptacles 318 and 320 via transport system 406 under the control of controller 322 for providing the first and second toner 319 and 321 at a ratio for achieving the associated selected gloss level. The blending receptacle 702 is provided with a blending device 704 that blends the first and second toner 319 and 321 to produce a homogeneous toner mixture 705. The blending performed in the blending receptacle 702 need not be as aggressive as the blending performed in blend and charge device 410 and need not cause the charging of the toner particles being blended. The toner mixture 705 is transported from the blending receptacle 702 to the sump 404 where the particles of toner mixture 705 are charged via the blend and charge device 410 and transferred to the photoreceptor 302 via the particle transfer device 412. The blend and charge device 410 and/or the particle transfer device 412 may further blend the toner mixture 711. In FIG. 7 an exemplary view is shown in which the first and second toners 319 and 321 are not presently flowing. Toner mixture 411 which has already been produced from first and second toners 319 and 321 is shown held in sump 404.

The blending device 704 is a dry particle blending device such as described with respect to blending device 114. The transport path 706 may simply include a path from the blending receptacle 702 to the sump in which the transport is assisted by gravity. The transport path 706 may further be provided with dry particle transport control devices such as described with respect to transport control device 112.

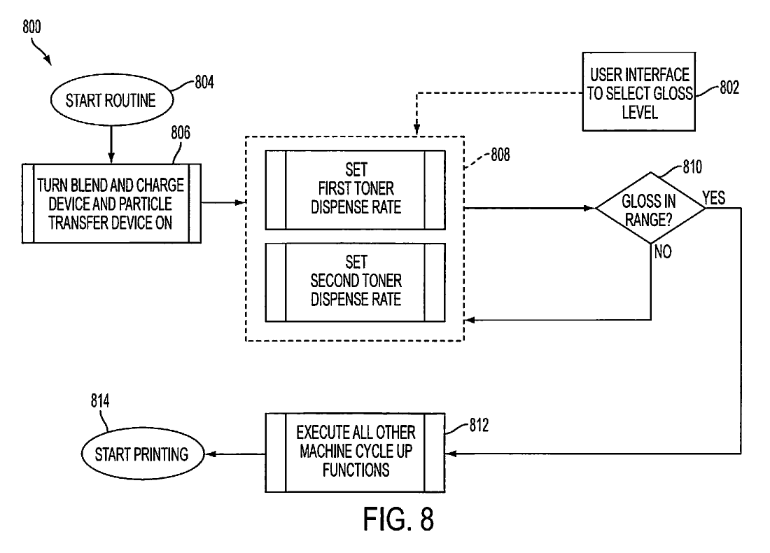

FIG. 8 is a flow diagram 800 showing steps that may be performed by the printing device 300 when a printing job is performed using an associated selectable gloss level. At step 802, a gloss level is selected, such as via the user interface 324. At step 804, the print routine is started. At step 806, the blend and charge device 410 and the particle transfer device 412 are actuated. At step 808, the dispense rates for the first and second toners 319 and 321 are set and the first and second toners 319 and 321 are dispensed to the sump 404 at the set rate.

At decision step 810, a determination is made if the gloss level associated with the toner mixture 411 is at the selected level. The determination is made by the controller 322 based on the amount of each of the toners 319 and 321 that have been dispensed into the sump 404. The controller 322 can determine the volume of toner dispensed from each receptacle 318 and 320 based on the dispense rate and the amount of time the dispensing was performed for. Furthermore, the controller 322 may know if any toner was in the sump 404 when the routine was started at step 804. The controller 322 further knows what the gloss level associated with the toner left in the sump from a previous print operation is. The printer device 300 may be configured for any toner left in the sump after a printing operation to be depleted or removed from the sump, or the printer device 300 may be configured so that toner left in the sump remains there for use during the next print operation. Under this condition, controller 322 determines the amount of toner that must be dispensed from the receptacles 318 and 320 so that the dispensed toner when mixed with the remaining toner that was left in the sump 404 from the previous print operation will be associated with the selected gloss level when blended together into the homogeneous toner mixture 411. In fact, the setting of the rates of dispensing at step 808 use information related to how much toner, if any, remains in the sump 404 from a previous print operation. At step 812, additional machine cycle-up functions are executed, such as, but not limited to, electrostatics control, toner concentration control, image density control, registration control, fusing temperature control, etc. At step 814, the printing is commenced.

The toners are described throughout the above description as being associated with a gloss level, since many factors can contribute to a gloss level of an image produced using the toner. For example, fuser heat or pressure for producing the image, as well as the angle of light impacting the image can affect how the gloss of the toner appears on the image. The gloss level referred to above as associated with the toner refers to one or more properties of the toner.

It will be appreciated that variations of the above-disclosed and other features and functions, or alternatives thereof, may be desirably combined into many other different systems or applications. Furthermore, the teachings herein can be applied to systems for producing toner or ink associated with a selected gloss level, including liquid ink, toner particles in a liquid solution and toner particles in a solid wax base material. The system may be incorporated into a printer device that uses liquid ink, toner particles in a liquid solution and toner particles in a solid wax base material. Also that various presently unforeseen or unanticipated alternatives, modifications, variations or improvements therein may be subsequently made by those skilled in the art which are also intended to be encompassed by the following claims.

What is claimed is:

1. A method for producing toner associated with a selectable gloss level, the method comprising:
holding a first toner formed of particles associated with a relatively low gloss level and having at least two particle properties, each of the at least two particle properties having a first and second characteristic, respectively;
holding a second toner formed of particles associated with a relatively high gloss level and having the at least two particle properties, each of the at least two particle properties having a third and fourth characteristic, respectively;
transporting the first and second toners;
determining a ratio of volume of the first and second toners that when blended produces a third toner associated with a selected gloss level in between the low gloss level and the high gloss level;
controlling the transporting of the first and second toners so that a ratio of a volume of the transported first and second toner is in accordance with the determined ratio; and
blending the transported first and second toners to produce the third toner;
wherein the first and third and the second and fourth characteristics are substantially the same, which enables the third toner to be blended into a substantially homogeneous mixture.

2. The method according to claim 1, wherein the at least two particle properties include a particle size distribution and a triboelectric potential.

3. The method according to claim 1, wherein the particles of the first dry toner and the particles of the second dry toner have at least one external additive, and the at least two particle properties include each external additive having an additive type and an additive level.

4. The method according to claim 1, further comprising the step of receiving an input specifying the selected gloss level.

5. The method according to claim 3, further comprising the step of optimizing the blending to form the homogeneous mixture without altering the particle properties related to the external additives of the first and second dry toners.

6. The method according to claim 3, further comprising the step of triboelectrically charging the particles of the first and second toners at substantially the same rate.

7. The method according to claim 7, wherein the transporting, blending and charging are performed in a printer device.

8. The method according to claim 8, further comprising the step of delivering the third toner to a photoreceptor of the printer device.

9. The method according to claim 1, wherein the third toner is stored in a removable receptacle.

10. A developer unit of a printer device comprising:
a first receptacle for holding a first toner formed of particles associated with a relatively low gloss level and having at least two particle properties, each of the at least two particle properties having a first and second characteristic, respectively;
a second receptacle holding a second toner formed of particles associated with a relatively high gloss level and having the at least two particle properties, each of the at least two particle properties having a third and fourth characteristic, respectively;
a transport system for transporting the first and second toners;
at least one blending device for blending the transported first and second toners to produce a third toner;
a controller for controlling the transporting so that the ratio of the volume of the transported first toner to the volume of the transported second toner is selected for the third toner to be associated with a selected gloss level in between the low gloss level and the high gloss level;
wherein the first and third and the second and fourth characteristics are substantially the same, which enables the third toner to be blended into a substantially homogeneous mixture.

11. The developer unit in accordance with claim 10, wherein the at least two particle properties include a particle size distribution and a triboelectric potential.

12. The developer unit in accordance with claim 10, wherein the particles of the first dry toner and the particles of the second dry toner have at least one external additive, and the at least two particle properties include each external additive having an additive type and an additive level.

13. The developer unit in accordance with claim 10, further comprising an interface for receiving an input specifying the selected gloss level.

14. The developer unit in accordance with claim 10, wherein the blending by the at least one blending device is optimized for the blending to form the homogeneous mixture without altering the particle properties related to the external additives of the first and second dry toners.

15. The developer unit in accordance with claim 10, wherein a blending device of the at least one blending device further triboelectrically charges the particles of the first and second toners at substantially the same rate.

16. The developer unit in accordance with claim 10, further comprising a particle transfer device for delivering the third toner to a photoreceptor of the printer device.

17. A toner having tunable gloss comprising a homogeneous mixture of:
a first toner formed of particles, associated with a relatively low gloss level, and having at least two particle properties, each of the at least two particle properties having a first and second characteristic, respectively; and
a second toner formed of particles, associated with a relatively high gloss level, and having the at least two particle properties, each of the at least two particle properties having a third and fourth characteristic, respectively, wherein the first and third and the second and fourth characteristics are substantially the same, which enables the toner having the tunable gloss to be blended into a substantially homogeneous mixture; wherein a proportion of the first and second toners is selected for the toner having tunable gloss to be associated with a selected gloss level.

18. The toner according to claim 17, wherein the at least two particle properties include a particle size distribution and a triboelectric potential.

19. The toner according to claim 17, wherein the particles of the first dry toner and the particles of the second dry toner have at least one external additive, and the at least two particle properties include each external additive having an additive type and an additive level.
